(19) United States
(12) Patent Application Publication
(10) Pub. No.: US 2026/0197363 A1
(43) Pub. Date: Jul. 9, 2026

(54) ADAPTABLE METRIC-DRIVEN MULTI-POLICY WORKLOAD PLACEMENT FRAMEWORK

(71) Applicant: Dell Products L.P., Round Rock, TX (US)

(72) Inventors: Claudio Romero, Rio de Janeiro (BR); Eduardo Vera Sousa, Niterói (BR); Paulo Abelha Ferreira, Rio de Janeiro (BR)

(21) Appl. No.: 19/012,747

(22) Filed: Jan. 7, 2025

(51) Int. Cl. H04L 67/1008; H04L 41/0894

(52) U.S. Cl. CPC H04L 67/1008; H04L 41/0894

(57) ABSTRACT

One example method for workload orchestration in a network includes receiving input comprising a composition of a set of infrastructure nodes, a batch of known workloads that need to be executed, and a list of policy requirements, providing the input to one or more policies of a policy catalogue, using the input to generate, for each of the policies, a respective workload placement plan, to create a collection of workload allocations, querying a knowledge base to gather metrics generated from previous executions of the workloads, building, using the metrics, a matrix which contains respective metrics for each one of the policies, evaluating, using the matrix, along with a requirement fulfillment matrix, the policies, considering the given one of the metrics, and outputting an identified one of the policies that optimizes the given metric.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to workload orchestration in a network. More particularly, at least some embodiments relate to systems, hardware, software, computer-readable media, and methods, for an adaptable metric-driven multi-policy workload placement framework.

### BACKGROUND

Cloud computing has gained the attention of businesses because of its benefits, which include pay-per-use computation at the costumer side, and resource sharing at the cloud computing service provider side. It is possible to offer computation agnostic to the underlying infrastructure. This can be achieved in the Platform as a Service (PaaS) or Function as a Service (FaaS, serverless computing) paradigms. In each of these paradigms, multiple metrics emerge such as, for example, response time, execution time and uptime, execution cost and energy efficiency. Using an infrastructure efficiently to execute jobs implies the adoption of a workload placement policy that will need to target these, sometimes conflicting metrics. In more detail, conventional approaches present a variety of challenges, which include, a multitude of available policies for workload placement, differing respective inputs/a priori knowledge for each policy, and different respective metrics optimized by each policy. As to the last, a further concern is that the particular metric(s) optimized by a given policy may not necessarily be the metric(s) desired by a user.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of use of a policy as a workload mapping function, according to one embodiment.

FIG. 2 discloses aspects of an algorithm that comprises an evaluator implementation, according to one embodiment.

FIG. 3 discloses a schema that comprises a method and architecture, according to one embodiment.

FIG. 4 disclosed a computing entity configured and operable to perform any of the disclosed methods, processes, steps, and operations.

### DETAILED DESCRIPTION OF SOME EXAMPLE EMBODIMENTS

Embodiments disclosed herein generally relate to workload orchestration in a network. More particularly, at least some embodiments relate to systems, hardware, software, computer-readable media, and methods, for an adaptable metric-driven multi-policy workload placement framework.

One or more embodiments may comprise an architecture and/or method operable to perform workload placement in a network that may comprise various nodes, possibly numbering hundreds, thousands, or more, that each comprise respective computing capabilities, such as in terms of storage, memory, processing, and communication bandwidth, for executing one or more workloads. An embodiment may operate in a dynamic fashion, making/updating workload placement decisions for a network in real time as (1) workloads come in, (2) policies change or are added/eliminated, and/or (3) node availability/capabilities change.

One such method according to an embodiment may comprise operations including: collecting, and providing as input, a composition of a set of infrastructure nodes, which are candidates do run the workloads, batch of known workloads that need to be executed, and a list of policy requirements; providing the input to one or more policies of a policy catalog; based on the input, generating, for each policy, a workload placement plan to define a collection of workload allocations; querying a knowledge base to gather metrics generated from previous executions of the workloads; using the metrics to build a M matrix, which contains p metrics for each one of q policies; using the M matrix alongside a requirement fulfillment matrix R to evaluate the policies, considering a given metric; and outputting an identified one of the policies that optimizes a given one of the metrics. Once the policy is identified, then the workload(s) May be orchestrated to one or more of the node(s) identified in the input.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may provide a single abstraction for policy execution simulation, where different policies can be represented in a single unifying format to enable the mapping of requirements and evaluation in a single framework. An embodiment may present a knowledge data base to store such requirements along with the required metrics for policy simulation. An embodiment May comprise an evaluator critic that implements a selection method for a policy pool that is efficient and abstracts away the different aspects that policies might have. An embodiment may perform a workload placement task targeting one or more metrics from a set of given metrics. An embodiment may adaptively select a ‘best’ policy to optimize the desired metric for the current workload batch, from a given workload catalog. An embodiment may adapt to new policies introduced in the future. Various other advantages of one or more example embodiments will be apparent from this disclosure.

### A. REFERENCES

Reference is made herein to various documents, listed below, which are incorporated herein in their respective entireties by this reference.
[1] Casas, Israel & Taheri, Javid & Ranjan, R. & Wang, Lizhe & Zomaya, Albert, “A balanced scheduler with data reuse and replication for scientific workflows in cloud computing systems,” Future Generation Computer Systems, 2016.
[2] Doraimani, Shyamala & Iamnitchi, Adriana, “File grouping for scientific data management: Lessons from experimenting with real traces,” 2008.
[3] Guo, Lizheng & Zhao, Shuguang & Shen, Shigen & Jiang, Changyuan, “Task Scheduling Optimization in Cloud Computing Based on Heuristic Algorithm,” Journal of Networks, 2012.
[4] U.S. patent application Ser. No. 18/602,188, entitled “DATA-AWARE WORKLOAD PLACEMENT USING REINFORCEMENT LEARNING,” filed Mar. 12, 2024.
[5] U.S. Pat. No. 11,349,728, entitled “DYNAMIC RESOURCE ALLOCATION BASED ON FINGERPRINT EXTRACTION OF WORKLOAD TELEMETRY DATA,” issued May 31, 2022.
[6] Zhao, Erdun & Yong-Qiang, Qi & Xing-Xing, Xiang & Yi, Chen, A Data Placement Strategy Based on Genetic Algorithm for Scientific Workflows, 2012.

### B. ASPECTS OF AN EXAMPLE CONTEXT FOR ONE OR MORE EMBODIMENTS

The following is a discussion of aspects of a context for one or more embodiments. This discussion is not intended to limit the scope of the claims or this disclosure, or the applicability of the embodiments, in any way.

One general problem addressed by an embodiment is how to efficiently execute a batch of jobs, or a workload, on a given infrastructure such as a network, while targeting one, or more, metrics such as response time, execution time, execution cost or energy efficiency. Any workload placement approach targeting these, typically conflicting goals, will be faced with multiple challenges. Such challenges include: a multiplicity of available policies; differing respective inputs/a priori knowledge for each policy; and, policies that each optimize for different respective metrics.

Thus, an embodiment may comprise an approach to address a three-fold task, namely: (1) perform a workload placement task targeting one or more metrics from a set of given metrics; (2) adaptively select a ‘best’ policy to optimize the desired metric for the current workload batch, from a given workload catalog; and (3) adapt to new policies introduced in the future. For example, one or more embodiments comprise a framework for workload placement that can incorporate multiple policies and adaptively select the best one from a given workload batch and target metric. To create a workload placement plan, an embodiment may use policies, which are functions that build placement plans for a batch of workloads to a set of infrastructure nodes.

### C. OVERVIEW OF ASPECTS OF ONE OR MORE EMBODIMENTS

An embodiment may tackle a three-fold task: (1) perform workload placement policy targeting one or more from a set of given metrics; (2) adaptively select a ‘best’ policy to optimize the desired metric for the current workload batch (from a given workload catalog); (3) adapt to new policies that could be added. to this end, a framework according to one embodiment may comprise various aspects, including: (1) single abstraction for policy execution simulation; (2) telemetry knowledge base (KB) to store policy requirement and metrics (used for policy simulation); (3) evaluator critic that implements a selection method for a policy pool; (4) adaptability via data collection for knowledge base update and incorporation of new policies.

### D. DETAILED DISCUSSION OF ASPECTS OF ONE OR MORE EMBODIMENTS

### D.1.1 Introduction

Typical workload placement strategies assume significant a priori knowledge of workloads and datasets. The type of knowledge required by different strategies can vary significantly. Below are some examples of assumptions commonly found in multiple approaches:
1. Estimated execution times of all workloads: This is one of the assumptions of the scheduler proposed in [1].
2. Estimated transfer times of all datasets to all possible nodes: This is another of the assumptions of the scheduler proposed in [1] as well as being necessary to measure data movement, that is, the time spent in the transfer of datasets between nodes, whose reduction is a goal (implicitly or explicitly) of several placement strategies including the ones in [2] and [3].
3. Historical dataset usage: In [2], as part of the proposed workload scheduling algorithm, datasets are grouped by their historical usage, that is, when a specific dataset was requested which, other datasets were also requested. The scheduling algorithm itself is based on the number of requests (popularity) of each group.
4. Complete knowledge of dataset dependency: In this context dataset dependency can have at least two distinct definitions: (a) which datasets a workload depends upon; and (b) datasets that represent the dependency between workloads, that is, a dataset that is the output of a workload and the input of another workload.

Regardless of definition, this is a common assumption of multiple workload placement approaches, such as the examples of [1], [2] and [3].

Reference [5] discloses a data dependency map, one of whose uses is to represent a dependency between datasets and workloads. As discussed elsewhere herein, one embodiment may employ such a data dependency map.

### D.1.2 Knowledge Base

One embodiment comprises a knowledge base, one or more examples of which are disclosed in [4]. This knowledge base contains information from previous workload executions. Elsewhere herein, execution time, dataset transfer time, historical dataset usage and knowledge of dataset dependency are presented as examples of information commonly assumed by different placement strategies. The first three can be directly obtained through simple database queries, and the last one may comprise a data dependency map, initially proposed in a previous invention disclosure [4], which may take various forms, such as a binary data structure.

From [4]:
[ . . . ] Such structure is a rank-2 tensor (i.e., a matrix) given by D_{p×q} where p is the number datasets and q is the number of workload types. One of the possible embodiments for this structure if we have five datasets (p=5) and two types of workloads (q=2) is:

$$D = [ \begin{matrix}0 & 1 \\ 1 & 0 \\ 1 & 0 \\ 0 & 1 \\ 1 & 1\end{matrix} ]$$

In this case, the first column represents the datasets needed by the workload type 0 (represented in this column), which are d₁, d₂ and d₄. Similarly, the second column represents the datasets required by the workloads type 1 (d0, d₃ and d₄) [ . . . ].

### D.2 Discussion

One or more embodiments comprise a framework for workload placement that is able to incorporate multiple policies and adaptively select a ‘best’ policy for a given workload batch and target metric(s). One embodiment comprises various aspects: (1) the updating of execution information on two data structures: requirements matrix and the metrics matrix; and (2) the second aspect of selecting policies.

In an embodiment, there may be various operations performed when selecting policies: (1) go to the requirements matrix and select only those that fulfill the given (current) requirements; (2) go to the metrics matrix and perform some form of MinRank to select among one or more metrics for the policies that minimize (maximize) them; (3) there might be budget restrictions, and if so, perform a cut off for policies above a given budget.

### D.2.1 Single Abstraction for Policy Execution Simulation

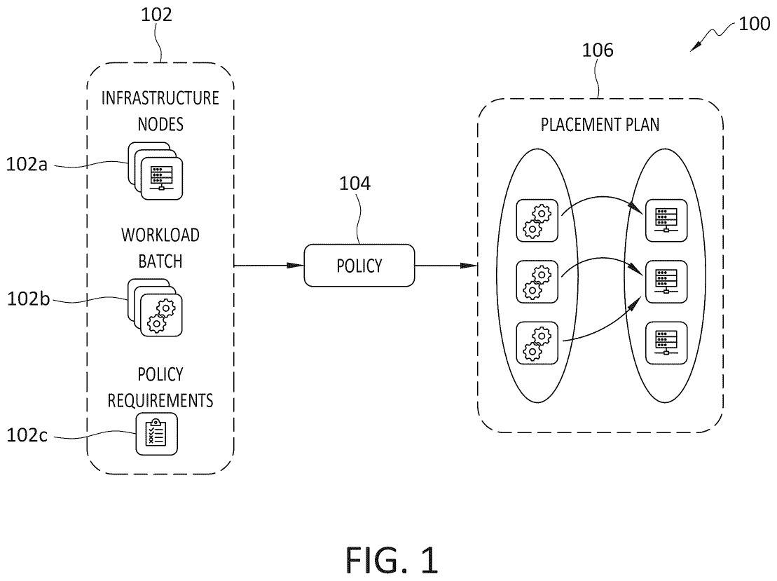

In an embodiment, a ‘policy’ refers to a placement policy π: W, Θ→N as a function that builds a placement plan for a batch of workloads W to a set of infrastructure nodes N while considering the requirements Θ. In practical terms, the policy function builds a set of actions that must be taken in order to process the batch, for example, execute workload wk in the infrastructure ni). The policy requirements Θ=[θ₁, θ₂, . . . , θₛ] is a binary vector that encodes the availability of the data needed to run a policy, such as by using an API or as provided in a file, like cost information, regulatory compliance data, such as GDPR, geographic constraints, and a workload dependency map. Thus, if θ₂ corresponds to cost information of using each infrastructure, for example, and this data is available, the value of θ₂ is 1 or 0 otherwise. FIG. 1 depicts the policy as a mapping function.

In particular, FIG. 1 discloses a schema 100 in which various inputs 102 are provided to one or more policies 104 which then generate a respective placement plan 106 for each policy. In the example of FIG. 1, the inputs 102 may comprise, for example, a set of infrastructure nodes 102a known, or expected, to be available for workload placement, a batch of workloads 102b to be orchestrated to the nodes, and one or more sets of policy requirements 102c.

In an embodiment, a round robin workload placement policy, for example, aims to optimize the fairness of a given infrastructure time, or set of infrastructures, among the multiple workloads. Other examples of placement policy include a reinforcement learning-based policy that aims to minimize the money spent at a given IaaS provider by allocating workloads with a given characteristic in a provider X instead of a provider Y. It is noted that, despite building a placement plan, a policy does not execute it the placement plan. Rather, the execution of the placement plan is a task for a different portion of an embodiment of a framework.

### D.2.2 Knowledge Base to Store Execution Telemetry Metadata

Given that most workload placement policies assume significant a priori knowledge, a framework according to one embodiment gathers execution telemetry metadata, such as execution time, dataset transfer time, and dataset correlation, to generate a knowledge base with the data required by these policies. Thus, an embodiment may obtain information about each one of the previous workload executions.

Let nᵢ=π(wₖ, θ) be the infrastructure node chosen by the policy π to execute the workload wₖ based on the requirements θ. Here, there are a few scenarios to explore:
Scenario I—Assume there is no information about previous executions of wₖ in ni. Once a placement plan is executed, an embodiment may capture telemetry data-such as CPU and RAM usage for example—and the values for the set of metrics M=[m₁, m₂ . . . mₚ], where m₁ could refer to processing time, m₂ to money spent, m₃ to data transfer time and so forth. It is noted that this approach enables an embodiment to incorporate new policies straightforwardly just by adding them to the policy catalog. An embodiment may provide the metrics M as one of the inputs for a subsequent pipeline step; and
Scenario II—There is information available about a previous execution of wₖ in ni and about the desired metric(s). In this case, an embodiment may simply query the knowledge base for the metrics M corresponding to this execution and provide M as input for a subsequent pipeline step.

### D.2.3 Evaluator Critic that Implements a Selection Method for a Policy Pool

Recall that M=[m₁, m₂, . . . , mₚ] is p-dimensional vector, where each dimension corresponds to a specific metric to be evaluated. Let ME be the metrics vector obtained for the policy π. By aggregating the metrics generated for each one of the policies, an embodiment may have [symbol] =[M₁, M₂, . . . , M_{q}]. Alternatively, an embodiment may provide a matrix representation, given by [symbol] _{p×q} as shown below:

$${ℳ}_{p \times q} = [ \begin{matrix}{m}_{1}^{1} & {m}_{1}^{2} & … & {m}_{1}^{q} \\ {m}_{2}^{1} & {m}_{2}^{2} & … & {m}_{2}^{q} \\ ⋮ & ⋮ & ⋱ & ⋮ \\ {m}_{p}^{1} & {m}_{p}^{2} & … & {m}_{p}^{q}\end{matrix} ] ,$$

where

$${m}_{j}^{i}$$

corresponds to the metric i obtained from the placement plan generated by the policy j. Additionally, there is a binary matrix [symbol] r×q=[Θ1, Θ2, . . . , Θq] that encodes the availability of all the requirements needed to run the policies, given by:

$${ℛ}_{r \times q} = [ \begin{matrix}{θ}_{1}^{1} & {θ}_{1}^{2} & … & {θ}_{1}^{q} \\ {θ}_{2}^{1} & {θ}_{2}^{2} & … & {θ}_{2}^{q} \\ ⋮ & ⋮ & ⋱ & ⋮ \\ {θ}_{r}^{1} & {θ}_{r}^{2} & … & {θ}_{r}^{q}\end{matrix} ]$$

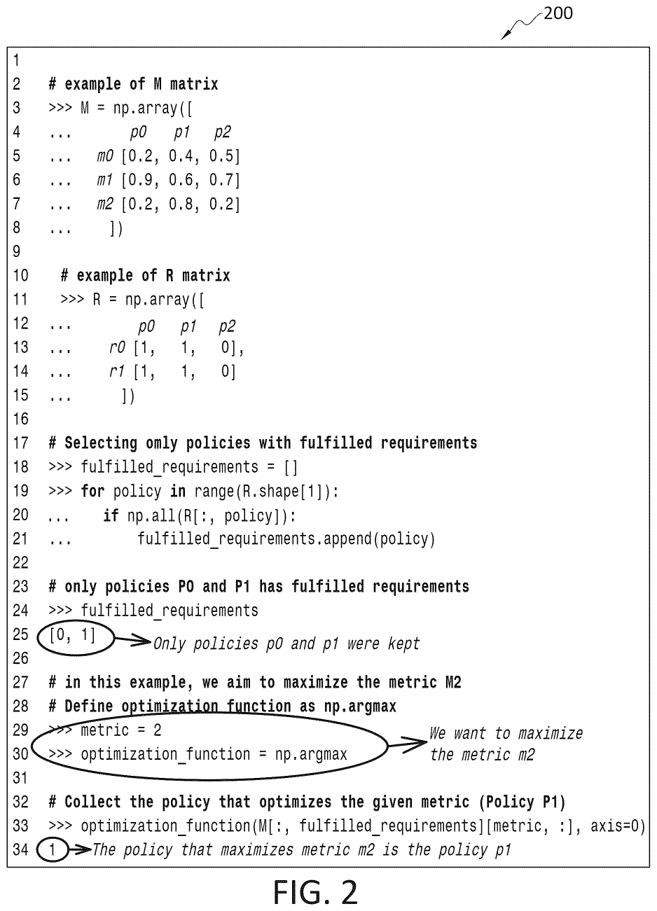

A policy selection method according to one embodiment may be based on the evaluation of both matrices [symbol] and [symbol] , where [symbol] defines which policies could be executed and [symbol] contains the values for each pair policy x metric. An example algorithm 200 for an embodiment of an evaluator implementation is provided in FIG. 2, where:
p₀, p₁ and p₂ are policies;
m₀, m₁ and m₂ are metrics; and
r₀ and r₁ are requirements.

In addition to what is presented in the above example, an embodiment may operate to filter [symbol] by cutting off policies that do not adhere to budget restrictions. In the above example, if p₁ exceeded the available budget in a IaaS provider, then the selected policy would have been p₀ selected, assuming this policy did not exceed a budget constraint.

### D.2.4 Overall Orchestration Pipeline

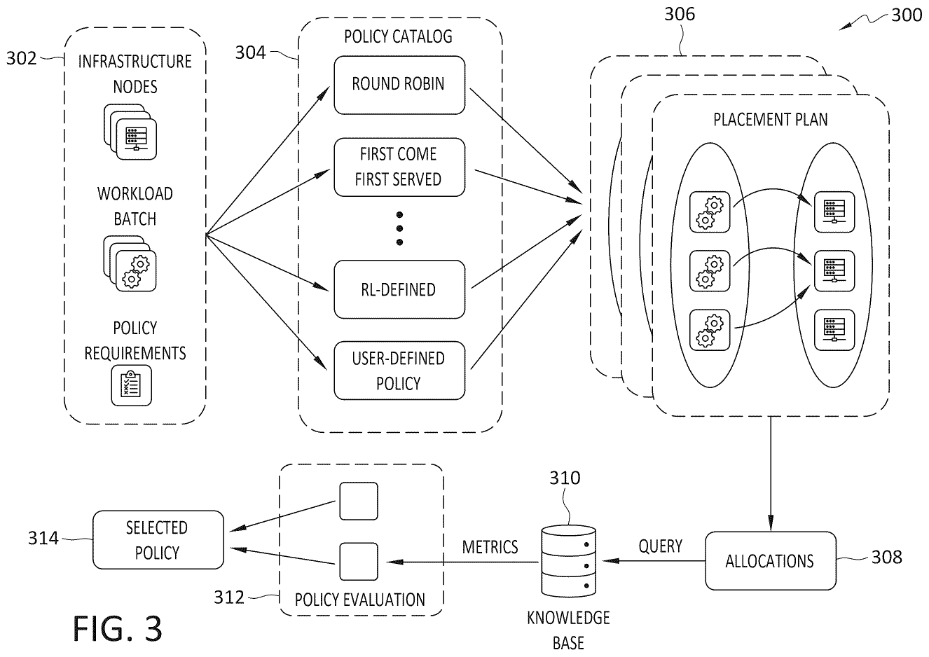

With attention now to FIG. 3, an example orchestration pipeline 300 according to one embodiment is disclosed. In an embodiment, the orchestration pipeline 300 may operate to perform, and/or direct the performance of, the operations set forth below:
I. The pipeline input 302—which may be the same as the input 102—may be provided as a composition of (a) a set of infrastructure nodes, which are candidates that run the workloads, and the input 302 may further comprise (b) a batch of known workloads that need to be executed and (c) a list of policy requirements.
II. By submitting the input to each policy from a policy catalog 304, an embodiment may generate one placement plan 306 per policy of the policy catalog 304.
III. The placement plan(s) 306 may be considered as a collection of workload allocations 308 in infrastructures.
IV. An embodiment may collect those allocations and query a knowledge base 310 to gather the metrics generated from previous executions—it is noted that if no metric data is found or exists, an embodiment may proceed with the execution using a plan generated by a default policy or, alternatively, using a randomly selected placement plan and adding the telemetry gathered in this execution to the knowledge base.
V. Use the metrics to build a [symbol] matrix, which contains the p metrics for each one of the q policies.
VI. Use the [symbol] matrix alongside a requirement fulfillment matrix [symbol] to perform an evaluation 312 of the policies considering a given metric.
VII. The output of this framework is the policy 314 that optimizes the metric of interest.

### D.2.5 Adaptability Via Data Collection for KB Update and Incorporation of New Policies

A framework according to one embodiment achieves adaptability through the introduction of new policies and, as discussed earlier herein, the collection of new metrics and telemetry data. To introduce a new policy, that is, a policy that does not already exist in a policy catalog, an embodiment simply add it to the policy catalog, along with any changes needed to gather any new telemetry or metric. As disclosed herein, an embodiment may contend with two scenarios:
A new policy shares requirements with existing policies: If a new policy shares requirements, such as the metrics and/or telemetries it uses, with already existing policies, then the evaluator critic will immediately consider that new policy as it would with any other policy.
A new policy has new requirements: If a new policy requires a telemetry that was not previously gathered, such as energy consumption information for example, then the evaluator critic, as part of its evaluation of the R matrix, will not consider that new policy. As future executions gather this new telemetry, the new policy will eventually have its requirements met and will be considered by the evaluator critic, as any other policy.

### D.2.6 Further Discussion

As disclosed herein, embodiments may possess various useful features and aspects, although no embodiment is required to possess any of such features or aspects. The following examples are illustrative, but not exhaustive.

An embodiment may comprise a framework operable to implement workload placement adaptability via data collection for knowledge base update and incorporation of new policies. An embodiment may comprise a single abstraction for policy execution simulation, where different policies can be represented in a single unifying format to enable the mapping of requirements and evaluation in a single framework. An embodiment may comprise a knowledge data base to store such requirements along with the required metrics for policy simulation. An embodiment may comprise an evaluator critic that implements a selection method for a policy pool that is efficient and abstracts away the different aspects that policies might have.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. FURTHER EXAMPLE EMBODIMENTS

Following are some further example embodiments. These are presented only by way of example and are not intended to limit the scope of this disclosure or the claims in any way.
Embodiment 1. A method, comprising: A method for workload orchestration in a network, comprising operations including: receiving input comprising a composition of a set of infrastructure nodes, a batch of known workloads that need to be executed, and a list of policy requirements; providing the input to one or more policies of a policy catalogue; using the input to generate, for each of the policies, a respective workload placement plan, to create a collection of workload allocations; querying a knowledge base to gather metrics generated from previous executions of the workloads; building, using the metrics, a matrix which contains respective metrics for each one of the policies; evaluating, using the matrix, along with a requirement fulfillment matrix, the policies, considering a given one of the metrics; and outputting an identified one of the policies that optimizes the given metric.
Embodiment 2. The method as recited in any preceding embodiment, wherein the workload is orchestrated to one or more of the infrastructure nodes, in accordance with the policy that optimizes the given metric.
Embodiment 3. The method as recited in any preceding embodiment, wherein the composition of the sets of infrastructure nodes includes information concerning respective computing capabilities, and availability, of the infrastructure nodes.
Embodiment 4. The method as recited in any preceding embodiment, wherein any of the policies that do not adhere to a specified budget restriction are omitted from the matrix.
Embodiment 5. The method as recited in any preceding embodiment, wherein one of the policies is a newly added policy.
Embodiment 6. The method as recited in any preceding embodiment, wherein each of the policies is used as a mapping function to map the input to a respective one of the workload placement plans.
Embodiment 7. The method as recited in any preceding embodiment, wherein one or more of the operations are performed in real time as one of the policies is added, modified, or deleted.
Embodiment 8. The method as recited in any preceding embodiment, wherein the metrics generated from previous executions of the workloads comprise telemetry that includes information about computing resource usage.
Embodiment 9. The method as recited in any preceding embodiment, wherein requirements of one of the policies comprises a binary vector that encodes an availability of data needed to run a workload according to that one policy.
Embodiment 10. The method as recited in any preceding embodiment, wherein when a new policy is received, the new policy is added to the policy catalogue and, when a determination is made that the new policy requires telemetry not previously gathered in connection with the policies of the policy catalogue, the new policy is not used for workload orchestration until telemetry data relating to the new policy is collected.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

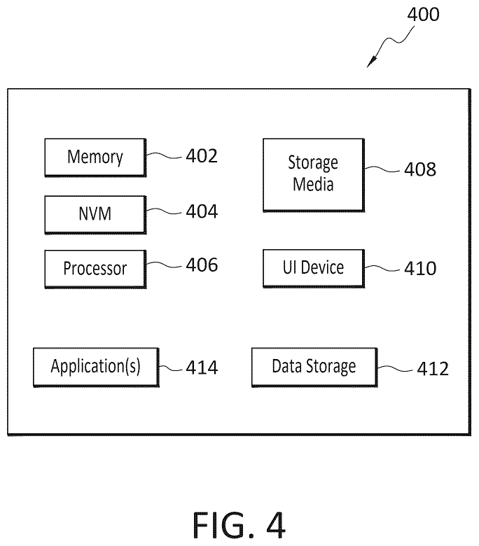

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for workload orchestration in a network, comprising operations including:
receiving input comprising a composition of a set of infrastructure nodes, a batch of known workloads that need to be executed, and a list of policy requirements;
providing the input to one or more policies of a policy catalogue;
using the input to generate, for each of the policies, a respective workload placement plan, to create a collection of workload allocations;
querying a knowledge base to gather metrics generated from previous executions of the workloads;
building, using the metrics, a matrix which contains respective metrics for each one of the policies;
evaluating, using the matrix, along with a requirement fulfillment matrix, the policies, considering a given one of the metrics; and
and outputting an identified one of the policies that optimizes the given metric.

2. The method as recited in claim 1, wherein the workload is orchestrated to one or more of the infrastructure nodes, in accordance with the policy that optimizes the given metric.

3. The method as recited in claim 1, wherein the composition of the sets of infrastructure nodes includes information concerning respective computing capabilities, and availability, of the infrastructure nodes.

4. The method as recited in claim 1, wherein any of the policies that do not adhere to a specified budget restriction are omitted from the matrix.

5. The method as recited in claim 1, wherein one of the policies is a newly added policy.

6. The method as recited in claim 1, wherein each of the policies is used as a mapping function to map the input to a respective one of the workload placement plans.

7. The method as recited in claim 1, wherein one or more of the operations are performed in real time as one of the policies is added, modified, or deleted.

8. The method as recited in claim 1, wherein the metrics generated from previous executions of the workloads comprise telemetry that includes information about computing resource usage.

9. The method as recited in claim 1, wherein requirements of one of the policies comprises a binary vector that encodes an availability of data needed to run a workload according to that one policy.

10. The method as recited in claim 1, wherein when a new policy is received, the new policy is added to the policy catalogue and, when a determination is made that the new policy requires telemetry not previously gathered in connection with the policies of the policy catalogue, the new policy is not used for workload orchestration until telemetry data relating to the new policy is collected.

11. A non-transitory storage medium having stored therein instructions that are executable by one or more hardware processors to perform operations comprising:
receiving input comprising a composition of a set of infrastructure nodes, a batch of known workloads that need to be executed, and a list of policy requirements;
providing the input to one or more policies of a policy catalogue;
using the input to generate, for each of the policies, a respective workload placement plan, to create a collection of workload allocations;
querying a knowledge base to gather metrics generated from previous executions of the workloads;
building, using the metrics, a matrix which contains respective metrics for each one of the policies;
evaluating, using the matrix, along with a requirement fulfillment matrix, the policies, considering a given one of the metrics; and
and outputting an identified one of the policies that optimizes the given metric.

12. The non-transitory storage medium as recited in claim 11, wherein the workload is orchestrated to one or more of the infrastructure nodes, in accordance with the policy that optimizes the given metric.

13. The non-transitory storage medium as recited in claim 11, wherein the composition of the sets of infrastructure nodes includes information concerning respective computing capabilities, and availability, of the infrastructure nodes.

14. The non-transitory storage medium as recited in claim 11, wherein any of the policies that do not adhere to a specified budget restriction are omitted from the matrix.

15. The non-transitory storage medium as recited in claim 11, wherein one of the policies is a newly added policy.

16. The non-transitory storage medium as recited in claim 11, wherein each of the policies is used as a mapping function to map the input to a respective one of the workload placement plans.

17. The non-transitory storage medium as recited in claim 11, wherein one or more of the operations are performed in real time as one of the policies is added, modified, or deleted.

18. The non-transitory storage medium as recited in claim 11, wherein the metrics generated from previous executions of the workloads comprise telemetry that includes information about computing resource usage.

19. The non-transitory storage medium as recited in claim 11, wherein requirements of one of the policies comprises a binary vector that encodes an availability of data needed to run a workload according to that one policy.

20. The non-transitory storage medium as recited in claim 11, wherein when a new policy is received, the new policy is added to the policy catalogue and, when a determination is made that the new policy requires telemetry not previously gathered in connection with the policies of the policy catalogue, the new policy is not used for workload orchestration until telemetry data relating to the new policy is collected.
